(19) United States
(12) Patent Application Publication
(10) Pub. No.: US 2006/0035652 A1
(43) Pub. Date: Feb. 16, 2006

(54) Short message service management system equipped with additional data transfer function

(75) Inventors: Woong-Cheol Kim, Seongbuk-Gu (KR); Sung-Woo Han, Dongjak-Gu (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: Pantech & Curitel Communications, Inc., Seocho-Gu (KR)

(21) Appl. No.: 11/144,687

(22) Filed: Jun. 6, 2005

(30) Foreign Application Priority Data
Jul. 29, 2004 (KR) 10-2004-0059899

(51) Int. Cl. H04Q 7/20

(52) U.S. Cl. 455/466

(57) ABSTRACT

Disclosed is an SMS management system equipped with an additional data transfer function. The SMS management system includes a message transmission module, wherein the message transmission module includes: a capacity calculating unit for calculating the volume of the message content entered by the message input unit and calculating a residual capacity by deducting the volume from the maximum capacity of a short message; an additional data processing unit for attaching additional data to the short message within the limit of the residual capacity calculated by the capacity calculating unit; and a message transmission unit for transmitting the short message with the attached additional data processed by the additional data processing unit to the recipient's mobile station number entered by the number input unit.

### BACKGROUND OF THE INVENTION

This application claims the priority of Korean Patent Application No. 2004-59899, filed on Jul. 29, 2004, in the Korean Intellectual Property Office, the disclosure of which is incorporated herein in its entirety by reference.

1. Field of the Invention

The present invention relates to a short message service (SMS) management system equipped with an additional data transfer function and, more particularly, to an SMS management system equipped with an additional data transfer function which makes it possible to attach and transmit additional data when the amount of message content is less than a maximum capacity available in transmitting a short message using a mobile station.

2. Description of Related Art

SMS is a sort of a wireless data communication service which enables a sender to transmit low volume data, such as text, to a recipient using a mobile communication service.

FIG. 1 is a schematic view of an SMS system.

A call signal and a short message transmitted from a sender's mobile station 11 or 12 are subjected to radio signal processing, and transmitted to a recipient's mobile station 14 through a base station 20 and a mobile switching center (MSC) 30 on the sender's side, and a mobile switching center 31 and a base station 21 on the recipient's side. At this time, short message service centers (SMSCs) 40 and 41, which store short messages and then deliver them to a destination user when they are available, are connected to corresponding MSCs to process the short messages.

Meanwhile, the short message can be transmitted to the recipient's mobile station 14 through a sender's personal computer 13 connected to the SMSC 40 via the Internet as well as through the sender's mobile station 11 or 12.

The total amount of data transmitted through the SMS varies according to the mobile communication system. A CDMA (code division multiple access) scheme can transmit data with a size of up to 80 bytes in each message, while a GSM (global system for mobile communications) scheme, which is widely used throughout the world, can transmit data with a size of up to 140 bytes.

The GSM scheme employs an EMS (enhanced messaging service) feature which can send and receive messages that have special text formatting (such as bold or italic), animations, pictures, icons, sound effects and special ring tones. In addition, the GSM scheme specifies a method of concatenating a message with a size exceeding a maximum capacity and a method of compressing data to be transmitted.

Up until now, techniques of increasing transmission capacity have been mainly developed because users have been concentrate their attention only on sending and receiving large-sized data, but not on taking advantage of a capacity remaining when users transmit small-sized data.

That is, in the case where a data amount sent by a user is less than the maximum data amount that can be sent per transmission as defined by the SMS specification, the residual space available for the message transmission is discarded although the user is billed a flat rate for each message. Consequently, the user has wasted money by failing to utilize the full data capacity for which they have paid and wireless resources have been wasted.

### SUMMARY OF THE INVENTION

The present invention provides an SMS management system equipped with an additional data transfer function which can minimize waste of wireless resources by transmitting additional data using the residual space available for message transmission in the case where a data amount sent by a user is less than the maximum data amount that can be sent per transmission as defined by an SMS specification.

In accordance with an aspect of the present invention, there is provided an SMS management system equipped with an additional data transfer function comprising a message transmission module, wherein the message transmission module comprises: a message input unit for receiving message content entered by a sender; a capacity calculating unit for calculating the volume of the message content entered by the message input unit and calculating a residual capacity by deducting the volume from the maximum capacity of a short message; an additional data processing unit for attaching additional data to the short message within the limit of the residual capacity calculated by the capacity calculating unit; a number input unit for receiving a recipient's mobile station number entered by the sender; and a message transmission unit for transmitting the short message with the attached additional data processed by the additional data processing unit to the recipient's mobile station number entered by the number input unit.

The message transmission module may further comprise an additional data selection unit for selecting additional data to be attached to the short message by the additional data processing unit.

The additional data selected by the additional data selection unit may be a plurality of segmented data generated by segmenting original data into smaller chunks and assigning individual identification numbers in a segmented order.

The additional data selection unit may be configured to allow a user to select the additional data to be attached to the short message.

The additional data selection unit may be configured such that the additional data to be attached to the short message is automatically selected in the order of identification numbers of the segmented data which is assigned the identification numbers in a segmented order.

The message transmission module may further comprise a transfer information storage unit for storing corresponding transfer information when the message transmission unit transmits the short message with segmented data attached as additional data to the recipient's mobile station number.

The message transmission module may further comprise a mode selection unit configured to allow a user to select the additional data transfer function.

The additional data processing unit may further attach a control bit, which represents whether or not additional data has been attached, to the short message.

The additional data processing unit may further attach additional data header information, which contains information about additional data, to the short message.

The system may further comprise an additional data generation module, wherein the additional data generation module comprises: an original data selection unit for allowing a user to select original data; a segmented data generation unit for generating segmented data by separating the original data selected by the original data selection unit into smaller chunks; an identification information assignment unit for assigning identification information to the individual segmented data generated by the segmented data generation unit in a segmented order; and a segmented data storage unit for storing the segmented data with the identification information assigned by the identification information assignment unit.

The segmented data generation unit may generate segmented data by segmenting the original data into smaller chunks and then compressing the individual segmented data.

In accordance with another aspect of the present invention, there is provided an SMS management system equipped with an additional data transfer function comprising a message reception module, wherein the message reception module comprises: a message reception unit for receiving a short message; a control bit reading unit for determining whether or not there is a control bit in the short message received by the message reception unit, the control bit representing whether or not additional data has been attached; a data separation unit for separating and storing message content and additional data from the short message if the control bit reading unit determines the additional data to have been attached to the short message; an additional data execution unit for executing the additional data separated by the data separation unit; and a message output unit for displaying the received message content on a display unit.

The data separation unit may determine whether or not the additional data is segmented data base on additional data header information incorporated in the short message, and the additional data execution unit may combine segmented data into original data and execute the original data after all the segmented data has been transmitted.

If the segmented data has been compressed, the additional data execution unit may decompress the segmented data, combine the segmented data into the original data, and execute the original data.

The additional data execution unit may allocate a memory region corresponding to the total size of the original data by reference to the segmentation information recorded in the header information of the segmented data, and record the segmented data from the first block to the last block sequentially in individual segmented regions of the memory region to restore the original data.

### BRIEF DESCRIPTION OF THE DRAWINGS

The above and other features and advantages of the present invention will become more apparent by the following detailed description of exemplary embodiments of the present invention by reference to the attached drawings in which:

FIG. 1 is a schematic view of an SMS system;

FIG. 2 is a schematic view showing an SMS management system equipped with an additional data transfer function according to the present invention;

FIG. 3 is a block diagram showing a message transmission module of the SMS management system equipped with an additional data transfer function according to an embodiment of the present invention;

FIG. 4 is a block diagram showing an additional data generation module of the SMS management system equipped with an additional data transfer function according to another embodiment of the present invention;

FIG. 5 is a block diagram showing a message reception module of the SMS management system equipped with an additional data transfer function according to another embodiment of the present invention;

FIG. 6 is a flowchart showing a message transmission operation in the SMS management system with an additional data transfer function according to the present invention;

FIG. 7 is a flowchart showing an additional data generation operation in the SMS management system equipped with an additional data transfer function according to the present invention;

FIG. 8 is a flowchart showing a message reception operation in the SMS management system equipped with an additional data transfer function according to the present invention;

FIG. 9A is a view showing a code system of a conventional short message; and

FIG. 9B is a view showing a code system of a short message containing additional data according to the present invention.

### DETAILED DESCRIPTION OF THE INVENTION

Exemplary embodiments according to the present invention will now be described in detail by reference to the accompanying drawings.

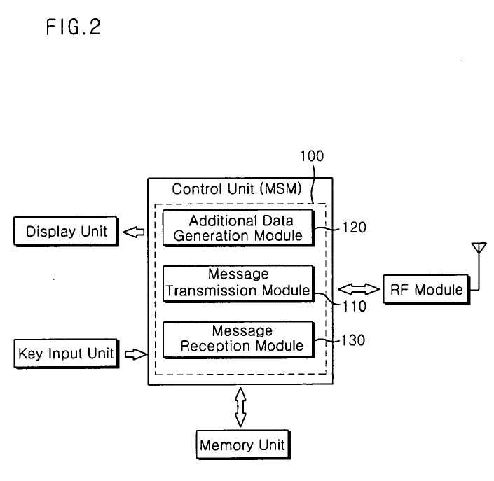

FIG. 2 is a schematic view showing an SMS management system equipped with an additional data transfer function according to the present invention.

The SMS management system 100 with an additional data transfer function according to the present invention exists in the form of software that is equipped into a mobile station. The SMS management system 100 comprises a message transmission module 110, an additional data generation module 120 and a message reception module 130.

The message transmission module 110 is responsible for calculating a residual capacity by deducting the volume of entered message content from the maximum capacity of a short message, attaching additional data to the short message within the limit of the residual capacity, and transmitting the short message together with the additional data, a control bit for indicating that the additional data has been attached, and additional data header containing information about the additional data.

The additional data generation module 120 is responsible for generating the additional data attached by the message transmission module 110, and separating original data into a plurality of segmented data.

The message reception module 130 detects the control bit in the transmitted short message to determine whether additional data is attached. If additional data is attached, the message reception module 130 processes the additional data according to the additional data header information and outputs the message content.

Therefore, the SMS management system equipped with an additional data transfer function according to the present invention can minimize waste of wireless resources by transmitting additional data using a residual capacity in the event that a data amount sent by a user is less than the maximum data amount that can be sent per transmission as defined in the SMS specification.

Such a technique of transmitting additional data using the residual capacity of a short message is highly useful for transmission of additional data, such as music or ringtone content or still or moving image content stored in one's mobile station, to a family, lover, or friend without extra transmission cost by using the residual capacity of a short message which is frequently sent.

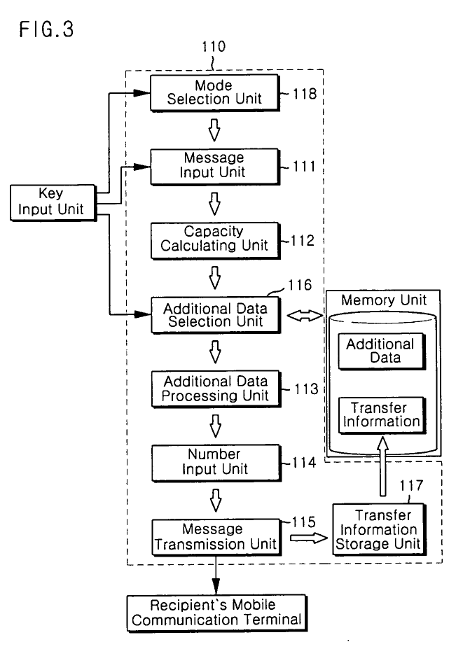

Referring to FIGS. 3 to 5, the construction of the present invention will be described in detail.

FIG. 3 is a block diagram showing a message transmission module of the SMS management system equipped with an additional data transfer function according to an embodiment of the present invention.

The message transmission module 110 in the SMS management system equipped with an additional data transfer function according to the present invention comprises a message input unit 111, a capacity calculating unit 112, an additional data processing unit 113, a number input unit 114 and a message transmission unit 115.

The message input unit 111 receives message content entered by a sender.

In other words, if the sender sends a short message to a recipient's mobile station number using his or her mobile station, the message transmission module 110 in the SMS management system 100 equipped with the additional data transfer function equipped into the mobile station provides a user interface (UI) for entering message content through the message input unit 111, and receives the message content entered by the sender using the UI.

The capacity calculation unit 112 calculates the volume of the message content inputted through the message input unit 111, and calculates a residual capacity by deducting the inputted volume from the maximum capacity of the short message.

When the message content is entered by the sender through the message input unit 111, the message transmission module 110 calculates the volume of the message content entered through the capacity calculating unit 112. For instance, a single Korean character requires 2 bytes of binary data while a single English alphabet requires 1 byte of binary data. Thus if 10 Korean characters are entered, the input volume calculated by the capacity calculating unit 112 is 20 bytes.

The capacity calculating unit 112 calculates the residual capacity by deducting the input volume from the maximum capacity of the short message. The CDMA scheme can transmit a maximum of 80 bytes of data per message; i.e., the maximum capacity of the short message is 80 bytes. Meanwhile, the GSM scheme can transmit a maximum of 140 bytes of data per message; i.e., the maximum capacity of the short message is 140 bytes.

For example, if a sender using a CDMA mobile communication service enters 10 Korean characters (20 bytes), the residual capacity calculated by the capacity calculating unit 112 is 60 bytes, which is obtained by deducting the input volume (20 bytes) from the maximum capacity (80 bytes). Conventionally, the residual capacity of 60 bytes has not been used, thus wasting wireless resources.

The additional data processing unit 113 attaches additional data to the short message within the limit of the residual capacity calculated by the capacity calculating unit 112.

That is, when the residual capacity is calculated by the capacity calculating unit 112, the message transmission module 110 incorporates message content entered by the sender and the additional data with a size equal to or less than the residual capacity attached by the additional data processing unit 113 into the short message to be transmitted to a recipient.

The number input unit 114 receives the recipient's mobile station number from the sender.

In other words, the message transmission module 110 provides a UI for entering the recipient's mobile station number to receive the short message with attached additional data through the number input unit 114, and receives the recipient's mobile station number entered by the sender using the UI.

The message transmission unit 115 transmits the short message with attached additional data processed by the additional data processing unit 113 to the recipient's mobile station number entered through the number input unit 114.

That is, if the sender pushes a send button by operating the key input unit of his or her mobile station, the short message with attached additional data is transmitted to the recipient's mobile station number.

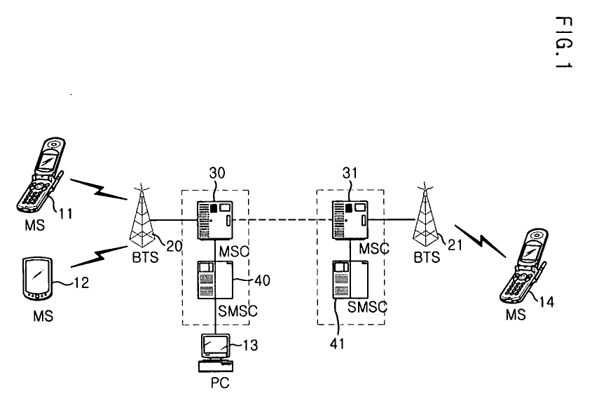

The short message with attached additional data transmitted in this manner is transmitted to the recipient's mobile station through the process shown in FIG. 1.

Accordingly, in the case where a data amount sent by a user through a software procedure from the mobile station is less than the maximum data amount that can be sent per transmission defined in the SMS specification, the SMS management system equipped with the additional data transfer function according to the present invention can transmit additional data using a residual capacity without the need to add additional software or device to the SMSC in a mobile communication system, thereby minimizing waste of wireless resources.

According to another preferred embodiment of the present invention, the message transmission module 110 of the SMS management system 100 equipped with an additional data transfer function according to the present invention further comprises an additional data selection unit 116.

The additional data selection unit 116 selects additional data to be attached to a short message by the additional data processing unit 113.

Preferably, the additional data selected by the additional data selection unit 116 is a plurality of segmented data that is created by separating original data into smaller chunks and assigning individual identification numbers in a segmented order.

That is, it is preferable to segment additional data into smaller chunks because the additional data to be transmitted using a residual capacity of a short message is more likely to be high volume data, such as music or ringtone content, or still/moving image content, and thus exceed the maximum capacity defined by the SMS specification. The above-mentioned data segmentation technique is well known in the art, and a detailed description thereof will thus be omitted.

The additional data section unit 116 can be implemented to allow a user to select the additional data to be attached to the short message, or can be implemented such that the additional data to be attached to the short message is automatically selected in the order of identification numbers of the segmented data which is assigned the identification numbers in a segmented order if original data is separated into smaller chunks.

In other words, it is possible to allow a sender to select additional data to be transmitted to a recipient by implementing to offer a UI used for selecting additional data to be attached to a short message by the sender through the additional data selection unit 116 and to allow the additional data processing unit 113 to attach the additional data selected by the sender through the UI to the short message.

In the case where the additional data is segmented data generated by separating original data into smaller chunks, it is preferred that the user selects the first of the segmented data according to the above-mentioned additional data selection procedure and the subsequent segmented data is automatically selected by the additional data selection unit 116 in the order of identification number of the segmented data. Thus, the message transmission module 110 automatically selects the segmented data except for already transmitted segmented data in the order of identification numbers by reference to transfer information of the segmented data (to be described later) each time the message transmission module 110 transmits the short message.

According to another preferred embodiment of the present invention, the message transmission module 110 in the SMS management system 100 equipped with an additional data transfer function further comprises a transfer information storage unit 117.

The transfer information storage unit 117 stores corresponding transfer information when the message transmission unit 115 transmits the short message with segmented data attached as additional data to the recipient's mobile station number.

That is, in the case where original high-volume data is segmented into smaller chunks and transmitted to the recipient's mobile station from the sender's mobile station via a plurality of short messages, it is preferred to transmit the segmented data in the order of identification numbers assigned based on a segmented order. Thus, the transfer information storage unit 117 stores transfer information containing identification numbers of segmented data having been transmitted and those of segmented data to be transmitted so that the message transmission module 110 can refer to the transfer information when transmitting the segmented data.

According to another preferred embodiment of the present invention, the message transmission module 110 in the SMS management system 100 equipped with an additional data transfer function further comprises a mode selection unit 118.

A user selects the additional data transfer function through the mode selection unit 118.

In other words, when a user creates a short message, the message transmission module 100 receives, through the mode selection unit 118, from the user about whether or not to transmit additional data using the residual capacity of the short message. If the user does not select the additional data transfer function, the short message is processed as in the conventional way. Alternatively, if the user selects the additional data transfer function, the process of attaching additional data to the short message is carried out.

According to another preferred embodiment of the present invention, the additional data processing unit 113 of the SMS management system 100 equipped with an additional data transfer function preferably further attaches a control bit to a short message. Here, the control bit indicates whether or not additional data has been attached.

In addition, the additional data processing unit 113 preferably further attaches an additional data header to a short message. Here, the additional data header contains information about additional data to be attached to the short message.

In other words, the additional data processing unit 113 in the message transmission module 110 records the control bit, which indicates whether or not additional data is attached, and the additional data header, which contains information about the attached additional data, such as information about a segmented original file, the identification of the segmented file, and the restoration of the segmented file, so that the recipient's mobile station having received a short message with the attached additional data processes the short message based on the control bit and the additional data header.

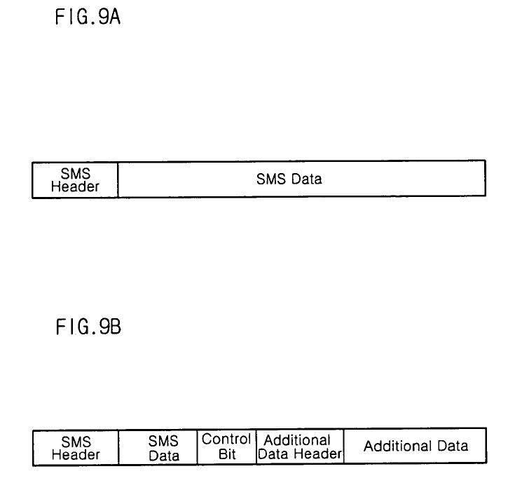

FIG. 9A is a view showing a code system of a conventional short message. FIG. 9B is a view showing a code system of a short message containing additional data according to the present invention. A conventional short message has a data code system consisting of an SMS header and SMS data (message content), while a short message with attached additional data according to the present invention has a data code system consisting of an SMS header, SMS data (message content), a control bit, an additional data header, and additional data.

Accordingly, the SMS management system 100 equipped with the additional data transfer function according to the present invention creates a short message with attached additional data and transmits the short message to the recipient's mobile station from the sender mobile station, by means of the message transmission module 110.

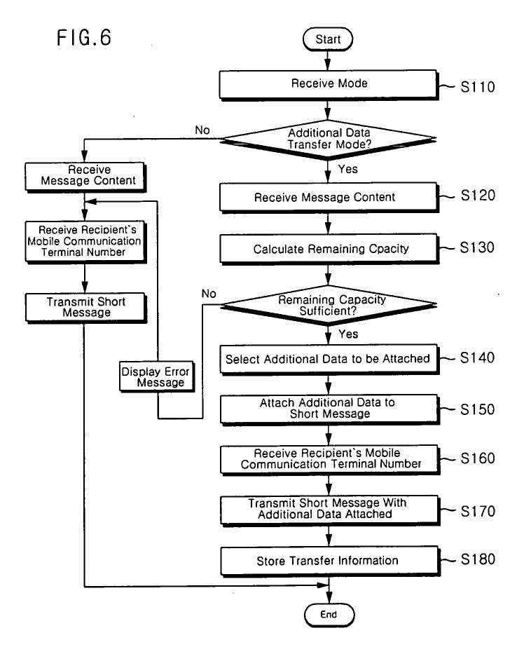

FIG. 6 is a flowchart showing a message transmission operation in the SMS management system equipped with an additional data transfer function according to the present invention.

When a sender accesses the SMS management system equipped with the additional data transfer function according to the present invention by operating his/her own mobile station, the message transmission module 110 receives an additional data transfer mode or a general short message mode from a user by means of the mode selection unit 118 (step S110).

If the general short message mode is selected by means of the mode selection unit 118, a typical short message processing process is performed as in the conventional way. If the additional data transfer mode is selected, the message transmission module 110 receives message content entered by the sender through the message input unit 111 (step S120).

Next, the message transmission module 110 calculates the volume of the message content entered by the sender through the capacity calculating unit 112, and calculates a residual capacity by deducting the input volume from the maximum capacity of the short message (step S130).

If the residual capacity is less than the minimum capacity for transmitting the additional data, an error message is displayed, the message transmission module 110 requests the sender to enter the mobile station number of the short message recipient, and transmits the short message incorporating the message content entered by the sender to the recipient's mobile station number.

If the residual capacity is greater than the minimum capacity for transmitting additional data, the message transmission module 110 receives the additional data to be attached to the short message selected by the sender by means of the additional data selection unit 116 (step S140).

The message transmission module 110 attaches the selected additional data to the short message within the limit of the residual capacity by means of the additional data processing unit 113 (step S150).

The message transmission module 110 receives the recipient's mobile station number by means of the number input unit 114 (step S160), transmits the short message with the attached additional data to the recipient's mobile station number by means of the message transmission unit 115 (step S170), and stores transfer information about the short message with the attached additional data by means of the transfer information storage unit 117 (step S180).

Accordingly, in the case where the data amount sent by a user through a software procedure from the mobile station is less than the maximum data amount that can be sent per transmission defined in the SMS specification, the SMS management system equipped with the additional data transfer function according to the present invention can transmit the additional data using the residual capacity without the need to add additional software or device in an SMSC of a mobile communication system, thereby minimizing waste of wireless resources.

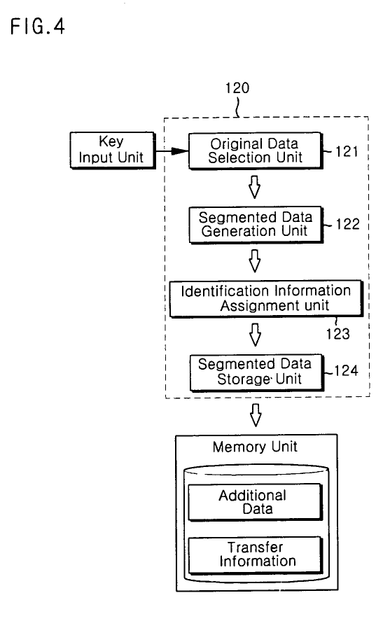

FIG. 4 is a block diagram showing an additional data generation module of the SMS management system equipped with an additional data transfer function according to another embodiment of the present invention.

The additional data generation module 120 of the SMS management system 100 equipped with an additional data transfer function according to the present invention comprises an original data selection unit 121, a segmented data generation unit 122, an identification information assignment unit 123 and a segmented data storage unit 124.

The original data selection unit 121 receives original data selected by the user.

That is, when the sender transmits additional data to the recipient's mobile station number using the residual capacity of the short message, the additional data such as music or ringtone content, or still/moving image content usually exceeds the maximum capacity of the short message, and thus needs to be segmented to be transmitted.

Therefore, the additional data generation module 120 offers a UI for selecting original data by means of the original data selection unit 121, and receives the original data selected by the user through the UI.

The segmented data generation unit 122 generates segmented data by separating the original data selected by the original data selection unit 121 into smaller chunks.

That is, if the original data is selected by the original data selection unit 121, the additional data generation module 120 generates segmented data by separating the original data into smaller chunks by means of the segmented data generation unit 122.

At this time, the segmented data generation unit 122 may generate the segmented data with a smaller size by segmenting the original data into smaller chunks and compressing the individual segmented data.

Techniques for segmenting and compressing data as set forth above are well known in the art, and their detailed description will thus be omitted.

The identification information assignment unit 123 assigns identification information to the individual segmented data generated by the segmented data generation unit 122 in a segmented order.

In other words, the individual segmented data generated by the segmented data generation unit 122 are attached to the short message, transmitted and combined to the recipient's mobile station. Thus, the additional data generation module 120 assigns identification information to the individual segmented data in a segmented order by means of the identification information assignment unit 123 so that the identification information can be referred to when the individual segmented data is attached to the short message or when the individual segmented data transmitted to the recipient's mobile station is combined.

The segmented data storage unit 124 stores the segmented data with the identification information assigned by the identification assignment unit 123.

That is, when the identification information is assigned to the individual segmented data in a segmented order by the identification information assignment unit 123, the additional data generation module 120 stores the segmented data with the assigned identification information by means of the segmented data storage unit 124.

That is, when the sender transmits a short message with additional data attached, the message transmission module 110 selects the segmented data created and stored by the additional data generation module 120, and transmits it to the recipient's mobile station.

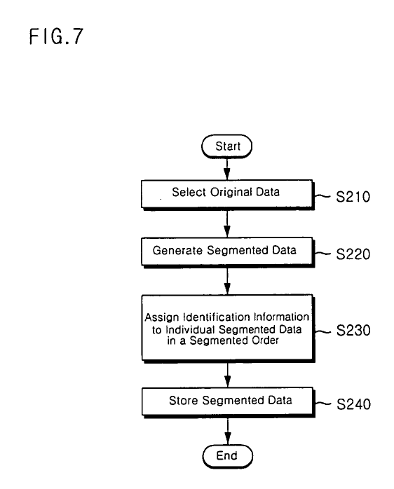

FIG. 7 is a flowchart showing an additional data generation operation in the SMS management system equipped with an additional data transfer function according to the present invention.

First, a user selects original data through the original data selection unit 121 in the additional data generation module 120 (step S210).

Next, the additional data generation module 120 generates segmented data by segmenting the original data into smaller chunks by means of the segmented data generation unit 122 (step S220). At this time, it is also possible to generate segmented data by segmenting the original data into smaller chunks and then compressing the individual segmented data.

Subsequently, the additional data generation module 120 assigns identification information to the individual segmented data by means of the identification information assignment unit 123 in a segmented order (step S230), and stores the segmented data with the assigned identification information by means of the segmented data storage unit 124 (step S240).

Accordingly, in the case where the additional data to be attached to the short message by means of the message transmission module 110 and to be transmitted to the recipient's mobile station is generated by the additional data generation module 120, the capacity of the additional data is usually greater than the maximum capacity of the short message. Thus, the additional data generation module 120 segments the original data into smaller chunks to generate and store segmented data, so that the individual segmented data is efficiently attached and transmitted using the residual capacity of the short message upon transmitting the short message to the recipient's mobile station by means of the message transmission module 110.

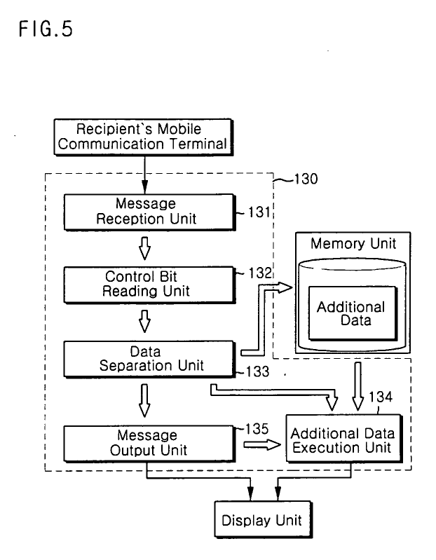

FIG. 5 is a block diagram showing a message reception module of the SMS management system equipped with an additional data transfer function according to another embodiment of the present invention.

The message reception module 130 of the SMS management system 100 equipped with an additional data transfer function comprises a message reception unit 131, a control bit reading unit 132, a data separation unit 133, an additional data execution unit 134, and a message output unit 135.

The message reception unit 131 receives a short message.

That is, when the short message is transmitted from the sender's mobile station or personal computer, the message reception modules 130 receives the short message transmitted by the sender through the message reception unit 131.

The control bit reading unit 132 determines whether or not there is a control bit in the short message received by the message reception unit 131. Here, the control bit indicates whether or not additional data is attached.

When the message reception unit 131 receives the short message, the message reception module 130 determines whether or not there is the control bit in the received short message by means of the control bit reading unit 132. If there is the control bit, the short message is determined to be a short message with attached additional data. If there is no control bit, the short message is determined to be a short message with no additional data attached.

The data separation unit 133 separates the message content and the additional data from the short message in the event that the control bit reading unit 132 determines the additional data to be attached to the short message.

If the control bit reading unit 132 determines the additional data to have been attached to the short message, the message reception module 130 separates and stores the message content and the additional data from the short message by means of the data separation unit 133.

The additional data execution unit 134 executes the additional data separated by the data separation unit 133.

That is, the message reception module 130 executes the received additional data in the recipient's mobile station by means of the additional data execution unit 134, so that the recipient views the additional data, such as music or ringtone content, or still/moving image content, transmitted by the sender.

The additional data execution unit 134 can be realized to implement various systems, such as a music playback system, a ringtone change system for changing a recipient's ringtone, a graphic viewing system for showing a still image, and a moving image playback system for playing a moving image, in a form of software based on the characteristics of the additional data transmitted from the sender, or can be realized to implement a combination of these systems.

The message output unit 135 displays the received message content on a display unit.

That is, when the control bit reading unit 132 determines the additional data to have been attached to the short message, when the segmented data attached to the short message is completely transmitted, or when the segmented data attached to the short message is completely transmitted and then executed by the additional data execution unit 134, the message reception unit 130 displays the received message content on the display unit of the recipient's mobile station through the message output unit 135 so that the recipient can read the message content.

Accordingly, the short message with the attached additional data, which is processed through the message transmission module 110 in the sender's mobile station and transmitted to the recipient's mobile station, is processed through the message reception module 130, so that the recipient reads the message content and the additional data.

In the SMS management system equipped with an additional data transfer function according to another preferred embodiment of the present invention, it is preferable that the data separation unit 133 determines whether or not the additional data is segmented data based on the additional data header information incorporated in the short message, and the additional data execution unit 134 combines the segmented data to execute the original data after all the segmented data has been completely transmitted.

That is, when the message transmission module 110 of the sender's mobile station transmits the short message with the attached segmented data, information about the segmented data, i.e., segmentation information, is recorded on the additional data header. At this time, the message reception module 130 of the recipient's mobile station determines whether or not the additional data attached to the short message is segmented data by reading the additional data header information incorporated in the short message by means of the data separation unit 133. After the segmented data has been completely transmitted, the additional data execution unit 134 combines the segmented data to restore the original data and reproduces the original data, thereby effectively processing the segmented data attached to the short message.

For example, when the data separation unit 133 determines the segmented data to have been completely transmitted, the additional data execution unit 134 combines the segmented data to restore the original data before reproducing the original data.

At this time, the additional data execution unit 134 allocates a memory region corresponding to the total size of the original data by reference to the segmentation information recorded in the header information of the segmented data, and records the segmented data from the first block to the last block sequentially in the memory region to restore the original data.

A technique of restoring the original data is well known in the art, a detailed description thereof will thus be omitted.

In the case where the segmented data has been compressed, it is preferable that the additional data execution unit 134 decompresses and combines the segmented data and executes the original data.

That is, when the message transmission module 110 in the sender's mobile station segments the original data into smaller chunks, compresses the individual segmented data, attaches the individual compressed segmented data to the short message and transmits the short message, the message reception module 130 in the recipient's mobile station receives the segmented data, decompresses the individual segmented data, combines the decompressed segmented data into the original data and reproduces the original data. Technique of decompressing the compressed data is well known in the art, and a detailed description thereof will thus be omitted.

Accordingly, the SMS management system 100 equipped with an additional data transfer function in accordance with the present invention receives a short message with attached additional data transmitted from the message transmission module 110 of a sender's mobile station by means of the message reception module 130 of a recipient's mobile station, separates the additional data from the short message, and executes the short message and the additional data by means of the recipient's mobile station so that the recipient can read the short message and the additional data.

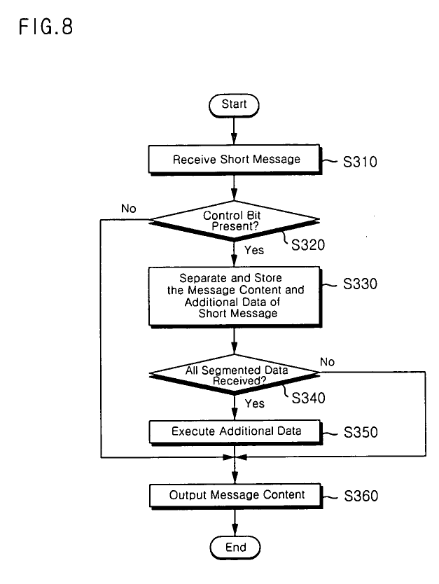

Referring to FIG. 8, the operation of the message reception module 130 will be described.

FIG. 8 is a flowchart showing a message reception operation in the SMS management system equipped with an additional data transfer function according to the present invention.

When a short message is transmitted to the recipient's mobile communication number from the sender's mobile station, the message reception module 130 receives the short message through the message reception unit 131 (step S310).

Next, the message reception module 130 determines whether or not there is a control bit, which indicates that additional data has been attached, in the short message received through the control bit reading unit 132 (step 320).

If the control bit is determined to be absent, a typical short message reception procedure is performed in such a manner that the short message is determined to be a general short message with no additional data attached and the message content is displayed on a display unit of the recipient's mobile station.

If the control bit is present, the short message is determined to be a message with additional data attached and the message reception module 130 separates and stores the message content and the additional data from the received short message (step S330).

Next, if the additional data is segmented data, the message reception module 130 determines whether or not all the segmented data have been received (step S340). If all the segmented data are received, the additional data is executed through the additional data execution unit 134 (step S350).

Finally, the message reception module 130 displays the message content on a display unit through the message output unit 135 (step S360).

Therefore, the short message with attached additional data which is processed through the message transmission module 110 in the sender's mobile station and transmitted to the recipient's mobile station is processed through the message reception module 130, so that the recipient can read the short message content and the additional data.

As described above, the SMS management system equipped with an additional data transfer function according to the present invention can minimize waste of wireless resources by transmitting additional data using a residual capacity when the data amount sent by a user is less than the maximum data amount that can be sent per transmission as defined in the SMS specification. Accordingly, the user can transmit a short message with additional data attached with no additional cost.

While the present invention has been described by reference to exemplary embodiments thereof, it will be understood by those skilled in the art that various changes in form and details may be made therein without departing from the scope of the present invention as defined by the following claims.

What is claimed is:

1. An SMS (short message service) management system equipped with an additional data transfer function comprising a message transmission module, wherein the message transmission module comprises:
a capacity calculating unit for calculating the volume of the message content and a residual capacity by deducting the volume from the maximum capacity of a short message;
an additional data processing unit for attaching additional data to the short message within the limit of the residual capacity calculated by the capacity calculating unit; and
a message transmission unit for transmitting the short message with the attached additional data processed by the additional data processing unit to a recipient's mobile station.

2. The system of claim 1, wherein the message transmission module further comprises an additional data selection unit for selecting additional data to be attached to the short message by the additional data processing unit.

3. The system of claim 2, wherein the additional data selected by the additional data selection unit is a plurality of segmented data generated by segmenting original data into smaller chunks and assigning individual identification numbers in a segmented order.

4. The system of claim 2, wherein the additional data selection unit is configured to allow a user to select the additional data to be attached to the short message.

5. The system of claim 3, wherein the additional data selection unit is configured such that the additional data to be attached to the short message is automatically selected in the order of identification numbers of the segmented data which is assigned the identification numbers in a segmented order.

6. The system of claim 5, wherein the message transmission module further comprises a transfer information storage unit for storing corresponding transfer information when the message transmission unit transmits the short message with segmented data attached as additional data to the recipient's mobile station.

7. The system of any one of claims 1 to 6, wherein the message transmission module further comprises a mode selection unit configured to allow a user to select the additional data transfer function.

8. The system of claim 7, wherein the additional data processing unit further attaches a control bit to the short message, the control bit representing whether or not additional data has been attached.

9. The system of claim 8, wherein the additional data processing unit further attaches additional data header information to the short message, the additional data header information containing information about additional data to be attached to the short message.

10. The system of any one of claims 3 to 6, further comprising an additional data generation module, wherein the additional data generation module comprises:
an original data selection unit for allowing a user to select original data;
a segmented data generation unit for generating segmented data by separating the original data selected by the original data selection unit into smaller chunks;
an identification information assignment unit for assigning identification information to the individual segmented data generated by the segmented data generation unit in a segmented order; and
a segmented data storage unit for storing the segmented data with the identification information assigned by the identification information assignment unit.

11. The system of claim 10, wherein the segmented data generation unit generates segmented data by segmenting the original data into smaller chunks and then compressing the individual segmented data.

12. An SMS management system equipped with an additional data transfer function comprising a message reception module, wherein the message reception module comprises:
a message reception unit for receiving a short message;
a control bit reading unit for determining whether or not there is a control bit in the short message received by the message reception unit, the control bit representing whether or not additional data has been attached;
a data separation unit for separating and storing message content and additional data from the short message if the control bit reading unit determines the additional data to have been attached to the short message;
an additional data execution unit for executing the additional data separated by the data separation unit; and
a message output unit for displaying the received message content on a display unit.

13. The system of claim 12,
wherein the data separation unit determines whether or not the additional data is segmented data base on additional data header information incorporated in the short message; and
wherein the additional data execution unit combines segmented data into original data and executes the original data after all the segmented data has been transmitted.

14. The system of claim 13, wherein, if the segmented data has been compressed, the additional data execution unit decompresses the segmented data, combines the segmented data into the original data, and executes the original data.

15. The system of any one of claims 12 to 14, wherein the additional data execution unit allocates a memory region corresponding to the total size of the original data by reference to the segmentation information recorded in the header information of the segmented data, and records the segmented data from the first block to the last block sequentially in individual segmented regions of the memory region to restore the original data.
